(19) United States
(12) Patent Application Publication
(10) Pub. No.: US 2017/0306871 A1
(43) Pub. Date: Oct. 26, 2017

(54) CONDITION-BASED POWERTRAIN CONTROL SYSTEM

(71) Applicant: Honeywell International Inc., Morris Plains, NJ (US)

(72) Inventors: Adrian Matias Fuxman, North Vancouver (CA); Daniel Pachner, Praha (CZ)

(21) Appl. No.: 15/139,035

(22) Filed: Apr. 26, 2016

(51) Int. Cl. F02D 41/02; F01P 7/16; F02D 41/28; F01P 7/02

(52) U.S. Cl. CPC F02D 41/021; F02D 41/28; F01P 7/026; F01P 7/16; F02D 2041/281

(57) ABSTRACT

A system and approach for development of setpoints for a controller of a powertrain system. The controller may be parameterized as a function of setpoints to provide performance variables that are considered acceptable by a user or operator for current operating conditions of the engine or powertrain. The controller may determine set point trajectories in real time during operation of the powertrain system and determine positions of manipulated variables do drive controlled variables to associated and determined set point trajectories. The present system and approach may determine set point trajectories for powertrain conditions on-line and in real time, whereas set point trajectories have previously been determined off-line for powertrain control.

### BACKGROUND

The present disclosure pertains to powertrain systems, and particularly to a control of engines and cooling systems. More particularly, the disclosure pertains to performance improvement of engines and cooling systems.

### SUMMARY

The disclosure reveals a system and approach for development of set points and set point trajectories for a controller of a powertrain system. A controller of the powertrain system may be configured to determine set points and/or set point trajectories for one or more conditions of the powertrain system. The controller may determine set points and/or set point trajectories for the one or more conditions of the powertrain system based, at least in part, on current operating conditions of the powertrain system and performance cost function. The controller may determine positions of actuators of the powertrain system to drive the conditions of the powertrain system to the determined set points and/or set point trajectories. The present system and approach may configure and update set points and set point trajectories for conditions of a powertrain system in real time and while the powertrain system is operating.

The approach described in this disclosure may be important for controlling transient performance of powertrain systems and/or be important for other purposes. This may be so because a standard approach for controlling performance of powertrain systems may consist of computing static offline set points as a function of disturbance variables, and for transient performance optimization, such an approach may require maps having large dimensions that may exceed memory available in the engine control unit and/or processing power thereof that may be present in an online environment. However, the disclosed system and approach may determine set points and/or set point trajectories online and in real time with less memory and processing power requirements than conventional approaches.

### BRIEF DESCRIPTION OF THE DRAWING

FIG. 1 is a schematic block diagram of an illustrative powertrain system;

FIG. 2 is a schematic block diagram of a controller of the illustration powertrain system;

FIG. 3 is a schematic diagram of an implementation of an illustrative powertrain condition management system;

FIG. 4 is a schematic diagram of an implementation of an illustrative powertrain condition management system; and

FIG. 5 is a schematic flow diagram of an illustrative approach for managing a condition of a powertrain system.

### DESCRIPTION

The present system and approach, as described herein and/or shown in the Figures, may incorporate one or more processors, computers, controllers, user interfaces, wireless and/or wire connections, and/or the like, wherever desired.

Transportation original equipment manufacturers (OEMs) may spend a large amount of time and money on a labor intensive process of designing setpoints for their powertrain controllers. A powertrain may incorporate an engine, a cooling system, and, in some instances, an exhaust gas aftertreatment mechanism. The powertrain may also incorporate a drivetrain and, in some setups, a vehicle associated with the drivetrain. Any reference to an engine, cooling system, powertrain or aftertreatment system herein, may be regarded as a reference to any other or all of these components.

One version of the present approach may leverage a powertrain controller to assist in the development of set points and/or set point trajectories for conditions of the powertrain system. The powertrain controller may be parameterized as a function of the set point trajectories to set actuator positions in real time (e.g., while the powertrain system is operating). Another version of the present approach may be a practical way for providing a user with information about how best to modify setpoints for a powertrain controller on-line and in real time.

A characteristic of powertrain condition management systems (e.g., a powertrain thermal management system or other powertrain system) may be that operating conditions (e.g., speed, load, and so forth) may change continuously or off and on while the powertrain is operating to meet the needs of an operator of the powertrain. In an example of powertrain thermal management systems, optimal temperatures (e.g., temperature set point trajectories of components of a powertrain system) for minimum fuel consumption and/or actuator power consumption may depend on current operating conditions of the powertrain system. One approach may control temperature set point trajectories of components of the powertrain system such that the temperatures may be driven to optimal values (e.g., set point trajectories) for a given economic cost function of operating the powertrain (e.g., to minimize fuel costs, energy consumption, and so on). In some cases, the economic cost function may take into consideration performance variables such as fuel consumption, energy consumption, parasitic losses, exhaust output, and so forth, when changes in operating conditions of the powertrain are measured or future changes to the operating condition may be available. Although the powertrain thermal management systems disclosed herein may be discussed primarily with respect to setting temperature set point trajectories, the disclosed concepts may be utilized with pressure set point trajectories (e.g., air-conditioning refrigerant), flow set point trajectories (e.g., coolant flow), and/or other condition set point trajectories of powertrain systems.

In some cases, set point trajectories for conditions of the powertrain may be maintained within one or more constraints. In one example, an economic cost function applied to the control of a powertrain system may be part of a model-predictive control (MPC) framework such that a control action may be generated while maintaining one or more conditions (e.g., a temperature condition, actuator positions, and so forth) within one or more constraints.

Although control strategies for set point trajectory regulation with set point trajectories from steady state optimization (e.g., off-line optimization) may be used; such control strategies may not provide optimal performance of the powertrain system because the set point trajectories may be set without taking into consideration current operating conditions of the powertrain system. In some cases, thermal management of a powertrain system may be investigated from a system modeling and/or optimization perspective, where the optimization of the powertrain system performance occurs on-line (e.g., in real time during operation of an engine or other component of the powertrain system).

Herein, one may discuss approaches and/or systems for optimization (e.g., on-line optimization) of powertrain thermal management in a model-based control framework. As discussed further below, the disclosed concepts may be implemented in one or more of two or more approaches which each address on-line optimization and control of powertrain thermal management.

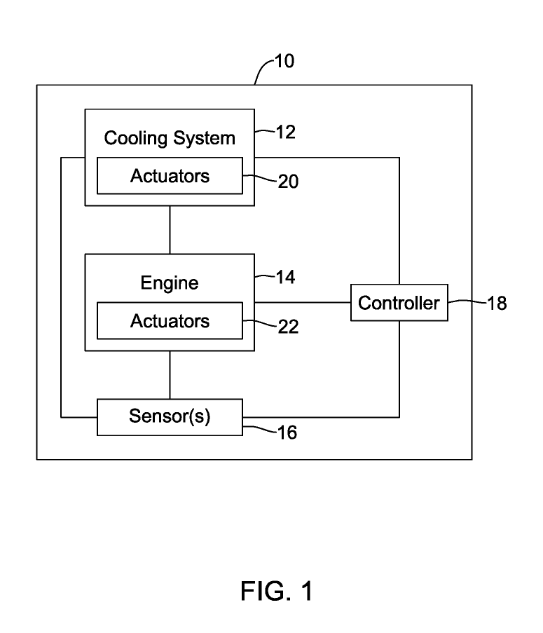

Turning to the figures, FIG. 1 depicts a powertrain system 10. The powertrain system 10 may include a cooling system 12, an engine 14, sensors 16, a controller 18, and/or one or more other components.

The cooling system 12 may be connected to the engine 14. Illustratively, the cooling system 12 may be configured to manage temperature values of powertrain components, including the engine 14.

One or more sensors 16 of the powertrain system 10 may be configured to sense one or more variables of the cooling system 12 and/or the engine 14. In some cases, the sensors 16 may be in communication with the controller 18 and configured to send sensed variable values to the controller 18.

The sensors 16 may be any type of sensor configured to sense a variable of the powertrain system. For example, the sensors 16 may include, but are not limited to, a temperature sensor, an absolute pressure sensor, a gage pressure sensor, a differential pressure sensor, a flow sensor, a position sensor, and/or one or more other types of sensors.

The controller 18 may be an electronic control module (ECM) or electronic control unit (ECU) with a control system algorithm therein. In one example, the control system algorithm may configure the controller 18 to be a multi-variable controller.

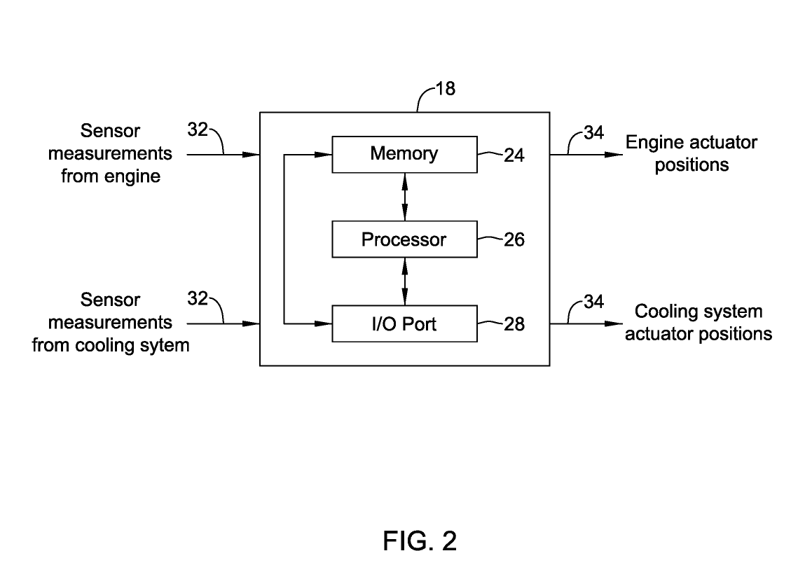

As seen in FIG. 2, the controller 18 may include one or more controller components having memory 24, a processor 26, an input/output (I/O) port 28, and/or one or more other components. The processor 26 may be in communication with the memory 24 and may be configured to execute executable instructions stored on the memory 24 and/or store and use data saved on the memory 24. In one example, the memory 24 may include one or more control system algorithms and/or other algorithms and the processor 26 may execute instructions (e.g., software code or other instructions) related to the algorithms in the memory 24.

The memory 24 may be any type of memory and/or may include any combination of types of memory. For example, the memory may be volatile memory, non-volatile memory, random access memory (RAM), FLASH, read-only memory (ROM), and/or one or more other types of memory.

The I/O port 28 may send and/or receive information and/or control signals to and/or from the cooling system 12, engine 14, one or more sensors 16, actuators, 20, 22, and/or other components of the power system 10 or components interacting with the power system 10. The I/O port 28 may be configured to communicate over a wired or wireless connection with other communicative components. Example wireless connections may include, but are not limited to, near-field communication (NFC), Wi-Fi, local area networks (LAN), wide area networks (WAN), Bluetooth®, Bluetooth® Low Energy (BLE), ZIGBEE, and/or one or more other non-proprietary or proprietary wireless connection.

In some cases, the controller 18 may be configured to control positions of actuators of the powertrain system 10 by outputting control signals 34 (e.g., control signals for setting actuator positions), as shown in FIG. 2, from the I/O port 28 or other port to drive conditions of powertrain system 10 components to an associated set point trajectory. The outputted control signals 34 may be based, at least in part on received values for one or more variables (e.g., sensor measurements 32 from components of the powertrain system 10 and/or other operating conditions, including actuator positions, of the powertrain system 10).

In one example controller 18, the controller 18 may be configured to control positions of actuators 20 of the cooling system 12, actuators 22 of the engine 14, and/or actuators of other components of the powertrain system 10 based at least in part, on receive values (e.g., from sensor measurements 32) of one or more variables. Example powertrain system 10 actuators include, but are not limited to, actuators of grill shutters, three-way valves, radiator fans, an engine pump, a turbocharger waste gage (WG), a variable geometry turbocharger (VGT), an exhaust gas recirculation (EGR) system, a start of injection (SOI) system, a throttle valve (TV), and so on. In some cases, sensors 16 may be configured to sense positions of the actuators.

As discussed and seen in FIG. 2, the controller 18 may be configured to receive values for one or more variables sensed by the sensors 16. Variables sensed by the sensors 16 may include one or more of engine in-cylinder wall temperature (e.g., temperature of a metal or other material of an engine), Tₘₑₜₐₗ, intake air temperature, T_{intake air}, engine oil temperature, T_{engine oil}, three-way valve position, grill shutter position, radiator fan position, engine pump position, engine speed, engine load, vehicle speed, and/or one or more other variables related to operation of the powertrain system 10.

The values of sensed variables (e.g., of sensor measurement signals 32) received at the controller 18 from the one or more sensors 16 may be indicative of one or more conditions of the cooling system 12 and/or the engine 14. The received variable values may be a condition of the cooling system 12 and/or the engine 14 or may be used in calculating or determining a condition of the cooling system 12 and/or the engine 14. Illustrative conditions of the cooling system 12 and/or the engine 14 may include temperature conditions, pressure conditions, flow conditions, and/or one or more other conditions.

The controller 18 may be configured to set and/or propose set point trajectories for conditions of the cooling system 12 and/or the engine 14. Once set point trajectories for conditions of the cooling system 12 and/or the engine 14 are determined, the controller 18 may be configured to adjust one or more positions of the actuators 20 of the cooling system 12 and/or actuators 22 of the engine 14 to drive a value of the one or more conditions to associated condition set point trajectories. Determining the set point trajectories and/or adjusting the actuators may be performed while the controller is on-line (e.g., the cooling system 12 and/or the engine 14 are operating (e.g., during steady state and/or transient operation of the powertrain system 10) and the controller may be receiving inputs from sensors 16) and/or other inputs in real-time.

As referred to above, condition set point trajectories for conditions of the cooling system 12 and/or the engine 14 may be determined in one or more manners. In one example, set point trajectories for conditions of the cooling system 12 and/or the engine 14 may be determined based on experience (e.g., testing) and/or modeling the cooling system 12 and the engine 14. Then, once data has been obtained from experience and/or modeling, set point trajectories for the conditions may be determined off-line and fixed for on-line consideration in setting positions of actuators of the powertrain system 10. Such a technique for determining set point trajectories does not necessarily take into consideration current operating conditions of the powertrain system 10.

Additionally, or alternatively, set point trajectories may be determined by the controller 18 while taking into consideration current operating conditions of the powertrain system. When considering current operating conditions (e.g., steady state and/or transient operating conditions) of the powertrain system 10, a controller 18 may be configured to determine set point trajectories for one or more conditions of a powertrain system 10 (e.g., conditions of a cooling system 12, engine 14, and/or other components of the powertrain system) based, at least in part, on a cost function that may optimize a set of performance variables of the cooling system 12 and/or the engine 14. Illustrative optimization of performance variables may include, but are not limited to, minimizing fuel consumption, energy consumption, minimizing parasitic losses, and so forth. In one example use of a cost function, a controller 18 may utilize a cost function configured to determine set point trajectories for one or more thermal conditions (e.g., oil temperature, engine temperature, speed of a variable speed cooling pump, and so forth) to minimize fuel consumption.

A cost function utilized by the controller 18 may take into consideration a model of the powertrain system 10, where the model may be represented by:

Cooling System/Engine Output: x_dot=F(x,u,w), Outputs: y=H(x,u, w) (1)

“x” may represent variables for which on-engine sensor measurements may be taken (e.g., states of variables such as pressure, temperature, concentrations, turbo speed, and so on). “u” may represent manipulated variables or inputs (e.g., signals from the controller 18 to operate actuators such as a 3-way valve, grill shutters, radiator fans, an engine pump, and so forth). “w” may represent exogenous inputs such as speed, fuel, ambient conditions, and so forth. These inputs may be measured. However, some outputs of the powertrain system 10 such as performance and quality variables may not necessarily be measured, but may be inferred, approximated by modeling, estimated by trials, calculated with algorithms, and other ways.

When considering a model of the cooling system 12 and/or the engine 14, such as equation (1), a non-linear cost function, for example, may take the following form:

$${min}_{u} J = f ( v ( u , w ) , w ) \qquad ( 2 )$$

where f(y,u) may represent variables of the cooling system 12 and the engine 14 that may have an impact on fuel economy (e.g., fuel consumption, energy consumption, parasitic losses, and so on) of the powertrain system 10. A mechanism for computing the actuator positions, u, in real-time such that it may optimize the cost function, J, may occur on a controller that may compute optimal set point trajectories for low-level controllers as follows:

$${min}_{\{ {y}_{—} {SP}_{1} , … {y}_{—} {SP}_{{N}_{p}} \}} J = {\sum }_{k = 1}^{{N}_{p}} ( f ( {y}_{k} , {w}_{k} ) + \vert \vert {y}_{—} {SP}_{k} - {y}_{—} {SP}_{k - 1} {\vert \vert}_{2}^{{R}_{Δ}} + \vert \vert ɛ {\vert \vert}_{2}^{G} ) \\ Subject to \text{:} \\ {y}_{k} = G ( {x}_{k} , {y}_{—} {SP}_{k} , {w}_{k} ) \\ {y}_{min} - ɛ \leq {y}_{k} \leq {y}_{max} + ɛ \qquad ( 3 )$$

where ∥y_SPₖ−y_SPₖ₋₁∥₂^{R}^{_{Δ}} may represent tuning of the controller 18, ∥ε∥₂^{G} may represent soft constraints on the model, and yₖ=G(xₖ, y_SPₖ, wₖ) and yₘᵢₙ−ε≦yₖ≦yₘₐₓ+ε_{V} may represent that the model is a closed-loop model. Here, k is a time index and y_SPₖ are the optimal set point trajectories computed by the controller.

At least in part because the model of the powertrain system 10 may be configured to output set point trajectories for the conditions of cooling system 12 and/or the engine 14, the cost function may determine set point trajectories for conditions of the cooling system 12 and/or the engine 14 in view of inputs from sensors 16 and/or other inputs, while minimizing costs and maintaining the set point trajectories and positions of actuators represented in the powertrain system model (e.g., equation (1)) within predetermined constraints. In one example, the controller 18 may be configured to determine thermal set point trajectories for the temperature of an engine housing, temperature of air in an engine intake manifold, temperature of air in an engine exhaust manifold, temperature of engine oil, temperature of transmission oil, and/or one or more other temperatures of components of the powertrain system 10. Additionally, or alternatively, set point trajectories may be determined for other conditions of the powertrain system 10, as desired. The controller 18 may be configured to update the set point trajectories of the conditions during operation of the cooling system 12 and/or engine 14 in view of received values for one or more variables sensed by the sensors 16 and/or other inputs.

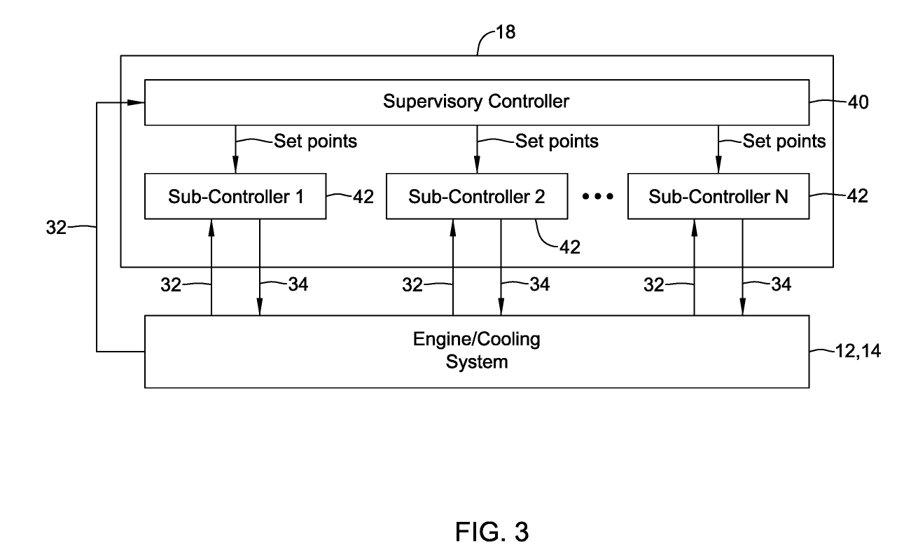

In some cases, the controller 18 (e.g., a multivariable controller based on Model Predictive Control (MPC)) may be and/or may include a supervisory controller 40 in communication with two or more powertrain component sub-controllers 42, as shown in FIG. 3. The supervisory controller 40 may be configured to include the model (e.g., equation (1)) of the powertrain system 10 and the cost function (e.g., equation (2)) of the powertrain system 10 and determine set point trajectories for one or more condition of the cooling system 12 and the engine 14 (e.g., a set point trajectory for a temperature condition of the cooling system 12 and/or the engine 14). As shown in FIG. 3, determined set point trajectories for conditions may be sent from the supervisory controller 40 to a sub-controller 42.

The sub-controllers 42 may be any type of controller. In one example, one or more sub-controllers 42 may be multivariable MPC based controllers configured to optimize output for one or more set point trajectories determined by the supervisory controller 40 and/or one or more sub-controllers 42 may be proportional-integral-derivative (PID) controllers configured to optimize output for a single set point trajectory determined by the supervisory controller 40.

In one example, the MPC based sub-controllers 42 may determine positions of actuators 20, 22 based on the following incoming sensor measurements 32 and the following cost function:

$$\begin{matrix}{min}_{\{ {u}_{1} , … {u}_{{N}_{p}} \}} J = {\sum }_{k = 1}^{{N}_{p}} ( \vert \vert {y}_{k} - {y}_{k}^{SP} {\vert \vert}_{2}^{Q} + \vert \vert {u}_{k} - {u}_{k}^{FF} {\vert \vert}_{3}^{{R}_{R}} + \vert \vert {u}_{k} - {u}_{k - 1} {\vert \vert}_{2}^{{R}_{Δ}} + \vert \vert ɛ {\vert \vert}_{2}^{G} ) \\ subject to \text{:} & ( 4 ) \\ {y}_{k} = L ( {x}_{k} , {u}_{k} , {w}_{k} ) \\ {u}_{min} \leq {u}_{k} \leq {u}_{max} \\ {y}_{min} - ɛ \leq {y}_{k} \leq {y}_{max} + ɛ & ( 5 )\end{matrix}$$

Here, yₖ^{sp} may represent a variable for which a set point trajectory was determined by the supervisory controller 40 and yₖ may represent a value sensed by sensors 16 for the variable (e.g., condition) for which a set point trajectory is provided. As the MPC based sub-controller 42 may be a multivariable controller, the MPC may set values (e.g., positions) for one or more manipulated variables (e.g., positions of actuators 20, 22) to drive controlled variables (e.g., conditions) to associated set point trajectories (e.g., set point trajectories of conditions).

PID sub-controllers 42 may include a control loop feedback mechanism. In one example, the PID sub-controller 42 may calculate an error value as a difference between a measured variable and a set point trajectory for that variable, as determined by the supervisory controller 40. Over time, the PID sub-controller 42 may attempt to minimize the error by adjusting values (e.g., positions) of a manipulated variable (e.g., positions of an actuator 20, 22) to drive controlled variables (e.g., conditions) to associated set point trajectories (e.g., set point trajectories of conditions).

Once the positions of the actuators 20, 22 have been set by the sub-controllers 42 to meet the set point trajectories determined by the supervisory controller 40, the actuator positions may be sent to the cooling system 12 and/or the engine 14 and values of variables sensed by sensors 16 may be provided back to the supervisory controller 40 for use as inputs in the powertrain system cost function to determine set point trajectories of conditions and repeat the above steps.

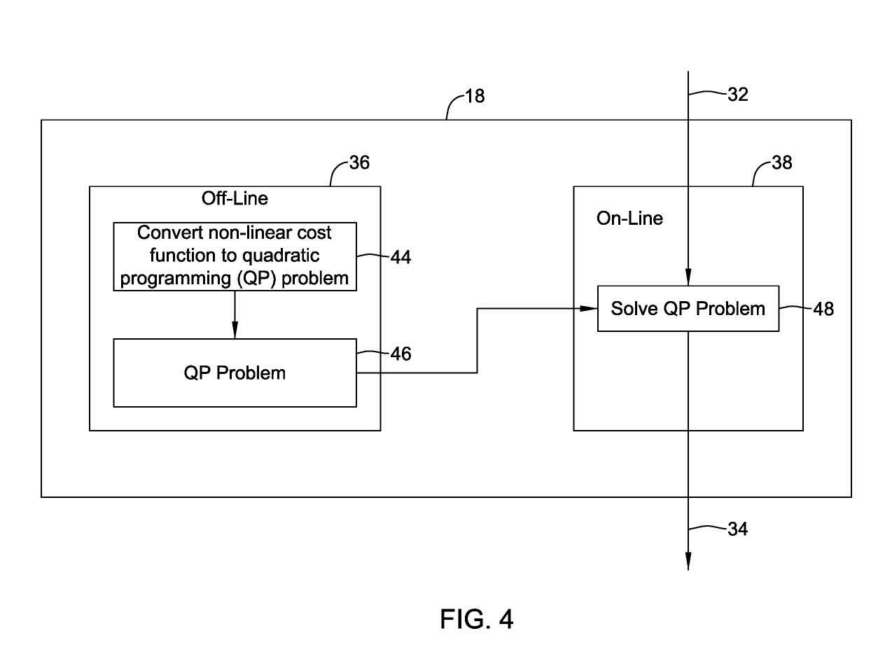

FIG. 4 depicts an additional or alternative mechanism in which the non-linear cost function in equation (2) may be transformed into a quadratic optimization problem. The transformation may change the performance cost function into a tracking problem of a few set points, where weak directions (e.g., directions where there may be little change in the cost) are removed. The set point trajectories and/or actuator positions for conditions of a powertrain system may be determined in real time, while a powertrain system 10 is operating (e.g., during steady state and/or transient operation of the powertrain system 10). In FIG. 4, the controller 18 (e.g., a multivariable controller) may include an off-line portion 36 and an on-line portion 38, where the on-line portion 38 may be configured to operate with inputs from components of the operating powertrain system 10, whereas the off-line portion 36 of the controller 18 may operate independent of components of the powertrain system 10 that are in operation.

As discussed herein, the controller 18 may be configured in one or more control components. In one example, off-line portion 36 of the controller 18 may be configured in a separate control component than a control component in which the on-line portion 38 may be configured. In such an instance, the off-line portion 36 may be configured on a personal computer, laptop computer, server, and so forth, which may be separate from the ECU/ECM of the powertrain system 10 in which the on-line portion 38 may be configured. Alternatively, or in addition, the controller 18 may be configured in one or more other control components.

The off-line portion 36 of the controller 18 may be configured in any computing device with processing power configured to convert 44 a non-linear cost function to a quadratic program (QP) problem. An illustrative non-linear model and cost function may be represented by:

$$\frac{{dx}_{t}}{dt} = f ( {x}_{t} , {u}_{t} , {w}_{t} ) , J = Σ j ( {x}_{k} , {u}_{k} , {w}_{k} ) , subject to \text{:} {A}_{i} [ \begin{matrix}{x}_{t} \\ {u}_{t}\end{matrix} ] \leq {b}_{i} \qquad ( 6 )$$

To facilitate converting the non-linear cost function to a QP problem, the functions f and j of equation (6) may be approximated as follows:

$$\frac{{dx}_{t}}{dt} \approx {x}_{t} + {B}_{u} {u}_{t} + {B}_{w} {w}_{t} , J \approx Σ \frac{1}{2} {( \begin{matrix}{x}_{k} \\ {u}_{k}\end{matrix} )}^{T} H ( {w}_{k} ) ( \begin{matrix}{x}_{k} \\ {u}_{k}\end{matrix} ) + {f ( {w}_{k} )}^{T} ( \begin{matrix}{x}_{k} \\ {u}_{k}\end{matrix} ) \qquad ( 7 )$$

Then, equation (7) may be converted 44 to a QP tracking problem 46 (e.g., using Hessian eigenvectors) and tuned to the controller, which may result in:

$$J = Σ \vert \vert z ( t + k ) - r ( t + k ) {\vert \vert}_{2}^{2} + {R}_{Δ} Σ \vert \vert u ( t - k ) - u ( t + k - 1 ) {\vert \vert}_{2}^{2} \qquad ( 8 )$$

The on-line portion 38 of the controller 18 may be configured to solve 48 the QP problem 46, as in equation (8), subject to:

$${z}_{t} = \sqrt{S} {V}^{T} [ \begin{matrix}{x}_{t} \\ {u}_{t}\end{matrix} ] \\ {r}_{t} = \sqrt{{S}^{- 1}} {V}^{T} f ( {w}_{t} ) \\ {x}_{t + 1} = {Ax}_{t} + {B}_{u} {u}_{t} + {B}_{w} {w}_{t} \\ F [ \begin{matrix}x ( t + k ) \\ u ( t + k )\end{matrix} ] \leq b \qquad ( 9 )$$

which may represent a linear plant model and constraints. From solving for equation (8) in view of equation (9), the on-line portion 38 may identify set point trajectories for conditions (e.g., thermal conditions) of the powertrain system 10. Then, based, at least in part, on the identified set point trajectories and current operating conditions of the cooling system 12, the engine 14, and/or other components of the powertrain system 10 (e.g., inputs 32 from sensors 16 and/or other values for operating variables including, but not limited to, positions of actuators), the on-line portion 38 of the controller 18 may optimize the cost function in view of the identified set point trajectories to determine positions of actuators 20, 22 of the cooling system 12 and/or engine 14 (and/or of other components of the powertrain system 10). The determined positions of actuators 20, 22 (e.g., manipulated variables) may be configured to drive values of one or more conditions (e.g., a controlled variable) to an associated set point trajectory and output 34 to various actuators 20, 22 of the powertrain system 10.

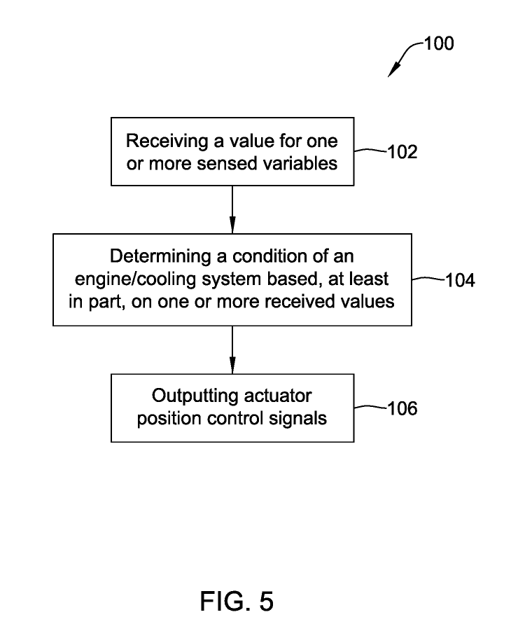

FIG. 5 depicts an illustrative approach 100 of thermal management of a powertrain system in accordance with the powertrain system 10 disclosed herein. The approach 100 may include receiving 102 one or more values for one or more variables sensed in a component (e.g., cooling system 12, engine 14, or other component) of the powertrain system 10. Based, at least in part, on the received value(s) for one or more variables sensed in the component(s) of the powertrain system 10, a set point trajectory for a condition (e.g., a temperature, pressure, flow, or other condition) of one or more components of the powertrain system 10 may be determined 104. In one example, the set point trajectory for the condition of the one or more components of the powertrain system 10 may be determined based, at least in part, on a cost function for the operation of the powertrain system 10 and/or a component thereof. Once, the set point trajectory or trajectories are known, the controller 18 may determine optimal positions of actuators (e.g., actuators 20, 22 or other actuators) of the cooling system 12, engine 14, and/or other components of the powertrain system 10 based on received inputs during operation of the engine 14 and/or other components of the powertrain system 10. These positions of actuators may be outputted 106 as control signals configured to accordingly adjust positions of the actuators 20, 22. In some cases, the control signals may be configured to adjust actuator positions to drive a value of one or more conditions (e.g., a temperature, pressure, and/or flow) of the powertrain system 10 or component thereof to an associated set point trajectory. In some cases, the approach 100 may be performed in real time during operation of one or more components of the powertrain system 10 and implemented in a manner similar to that discussed with respect to FIG. 3, FIG. 4, or a combination of FIGS. 3 and 4.

The following is a recap of the above disclosure. A powertrain system may include an engine, a cooling system, a controller connected to the engine and the cooling system, and one or more sensors. The cooling system may be connected to the engine and may include one or more actuators. The sensor(s) may be in communication with the controller and may sense values of one or more variables of the engine and/or the cooling system. The controller may be configured to control positions of the actuators of the cooling system and receive values of variable sensed by the sensors during operation of the engine. The received values for a sensed variable may be indicative of one or more conditions of the engine and/or the cooling system. The controller may be configured to further adjust one or more positions of the actuators of the cooling system to drive a value of the one or more conditions to associated condition set point trajectories for the engine and/or cooling system.

The controller of the powertrain system may be configured to determine condition set point trajectories associated with the one or more conditions of the engine and/or the cooling system. In some cases, the controller may determine condition set point trajectories associated with the one or more conditions based, at least in part, on a cost function that optimizes a set of performance variables of the engine and/or cooling system.

Further, the controller of the powertrain system may be configured to maintain each of the condition set point trajectories within predetermined constraints.

Further, the controller of the powertrain system may be configured to maintain actuator positions within predetermined constraints when determining the condition set point trajectories associated with the one or more conditions.

Further, the controller of the powertrain system may be configured to use the cost function and sensor inputs to minimize one or more of fuel consumption of the engine and parasitic losses of the engine while maintaining one or more of the conditions and the positions of the actuators of the engine within respective constraints.

The controller of the powertrain system may be configured to update the condition set point trajectories during operation of the engine and/or cooling system in view of received values for one or more variables sensed by the one or more sensors during operation of the engine.

In the powertrain system, a condition of the one or more conditions may include a temperature condition, where the powertrain system may have a temperature condition set point trajectory for the temperature condition. The temperature condition set point trajectory may include one or more engine component temperature set point trajectories. Illustratively, the engine component temperature set point trajectories may incorporate one or more of an engine housing material temperature set point trajectory, an engine intake manifold air temperature set point trajectory, an engine exhaust manifold air temperature set point trajectory, an engine oil temperature set point trajectory, and a transmission oil temperature set point trajectory.

The controller of the powertrain system may incorporate a multivariable supervisory controller and two or more powertrain component controllers. The multivariable supervisory controller may be configured to determine one or more temperature condition set point trajectories. Each of the two or more powertrain component controllers may adjust positions of actuators associated with the powertrain component controller to drive a value of the temperature condition to the temperature condition set point trajectory.

The multivariable supervisory controller and the powertrain component controllers may receive values for one or more variables. The received values for one or more variables may be sensed by the one or more sensors during operation of the engine.

The controller of the powertrain system may incorporate a multivariable controller that includes an off-line portion configured to operate without input from an operating engine and an on-line portion configured to operate with input from an operating engine.

In the powertrain system, the off-line portion of the multivariable controller may be configured to convert a non-linear cost function into a quadratic programming problem.

The on-line portion of the multivariable controller may be configured to determine the engine and/or cooling system actuator positions. The actuator positions may be determined by solving, at least in part, a quadratic programming problem in view of current operating conditions of the engine and/or cooling system.

The on-line portion of the multivariable controller may be configured to set positions of engine and/or cooling system actuators. The positions of the engine and/or cooling system actuators may be set in view of condition set point trajectories and current operating conditions of the engine and/or cooling system.

The one or more conditions of the engine and/or cooling system may include one or more of a pressure condition, a flow condition, and a temperature condition of one or more of the engine and/or cooling system.

A powertrain thermal management system may incorporate a controller with memory, a processor in communication with the memory and an input/output (I/O) port. The I/O port may be in communication with one or more of the memory and the processor. The controller may be configured to receive, via the input/output port, values for one or more variables sensed by sensors monitoring an engine and/or cooling system connected to the engine. Based, at least in part, on the received values for the one or more variables, the controller may determine a set point trajectory for one or more engine component and/or cooling system temperatures. Via the input/output port, the controller may send control signals to adjust positions of engine actuators and/or cooling system actuators to drive values of the engine component temperatures to the determined set point trajectories based, at least in part, on the received values for one or more variables.

The engine component and/or cooling system temperatures of the powertrain thermal management system may include one or more of an engine housing material temperature; an engine intake manifold air temperature; an engine exhaust manifold air temperature; an engine oil temperature; and a transmission oil temperature.

The controller of the powertrain thermal management system may determine the set point trajectory for one or more engine component temperatures and/or cooling system component temperatures based, at least in part, on a powertrain cost function.

An approach of thermal management of a powertrain system may incorporate receiving a value for one or more variables sensed in an operating engine and determining a set point trajectory for a temperature condition of the engine based, at least in part, on the received value for one or more variables sensed in the operating engine. Further, the approach may incorporate outputting one or more control signals controlling positions of actuators of the engine and/or positions of actuators of a cooling system connected to the engine during operation of the engine. The control signals may be configured to adjust one or more positions of the actuators of the engine and/or of the cooling system to drive a value of the temperature condition to the determined set point trajectory for the temperature condition.

In the approach, the set point trajectory for a temperature condition of the engine may be based, at least in part, on a cost function for the operation of the engine.

In the approach, determining a set point trajectory for a temperature condition of the engine may incorporate determining a temperature set point trajectory for one or more engine components of the operating engine.

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the related art to include all such variations and modifications.

What is claimed is:

1. A powertrain system comprising:
an engine;
a cooling system connected to the engine and having one or more actuators;
a controller connected to the engine and the cooling system;
one or more sensors in communication with the controller and configured to sense values of one or more variables of the engine and/or the cooling system; and
wherein the controller is configured to:
control positions of the one or more actuators of the cooling system;
receive values for one or more variables sensed by the one or more sensors during operation of the engine, where at least one received value for a sensed variable is indicative of one or more conditions of the engine and/or the cooling system; and
adjust one or more positions of the actuators of the cooling system to drive a value of the one or more conditions to associated condition set point trajectories for the engine and/or cooling system.

2. The system of claim 1, wherein the controller is configured to determine condition set point trajectories associated with the one or more conditions based, at least in part, on a cost function that optimizes a set of performance variables of the engine and/or cooling system.

3. The system of claim 2, wherein the controller is configured to maintain each of the condition set point trajectories within predetermined constraints.

4. The system of claim 2, wherein the controller is configured to maintain actuator positions within predetermined constraints when determining the condition set point trajectories associated with the one or more conditions.

5. The system of claim 2, wherein the controller is configured to use the cost function and sensor inputs to minimize one or more of fuel consumption of the engine and parasitic losses of the engine while maintaining one or more of the conditions and the positions of the actuators of the engine within respective constraints.

6. The system of claim 1, wherein the controller is configured to update the condition set point trajectories during operation of the engine and/or cooling system in view of received values for one or more variables sensed by the one or more sensors during operation of the engine.

7. The system of claim 1, wherein:
a condition of the one or more conditions includes a temperature condition having a temperature condition set point trajectory, wherein the temperature condition set point trajectory comprises one or more engine component temperature set point trajectories; and
the engine component temperature set point trajectories comprise one or more of:
an engine housing material temperature set point trajectory;
an engine intake manifold air temperature set point trajectory;
an engine exhaust manifold air temperature set point trajectory;
an engine oil temperature set point trajectory; and
a transmission oil temperature set point trajectory.

8. The system of claim 1, wherein:
the controller comprises a multivariable supervisory controller and two or more powertrain component controllers;
the multivariable supervisory controller is configured to determine the temperature condition set point trajectory; and
each of the two or more powertrain component controllers are configured to adjust positions of actuators associated with the powertrain component controller to drive a value of the temperature condition to the temperature condition set point trajectory.

9. The system of claim 8, wherein the multivariable supervisory controller and the powertrain component controllers receive values for one or more variables sensed by the one or more sensors during operation of the engine.

10. The system of claim 1, wherein the controller comprises a multivariable controller that includes an off-line portion configured to operate without input from an operating engine and an on-line portion configured to operate with input from an operating engine.

11. The system of claim 10, wherein the off-line portion of the multivariable controller is configured to convert a non-linear cost function into a quadratic programming problem.

12. The system of claim 11, wherein the on-line portion of the multivariable controller is configured to determine the engine and/or cooling system actuator positions by solving, at least in part, a quadratic programming problem in view of current operating conditions of the engine and/or cooling system.

13. The system of claim 10, wherein the on-line portion of the multivariable controller is configured to set positions of engine and/or cooling system actuators in view of condition set point trajectories and current operating conditions of the engine and/or cooling system.

14. The system of claim 1, wherein the one or more conditions of the engine and/or cooling system include one or more of a pressure condition, a flow condition, and a temperature condition of one or more of the engine and/or cooling system.

15. A powertrain thermal management system comprising:
a controller comprising:
a memory;
a processor in communication with the memory; and
an input/output port in communication with one or more of the memory and the processor; and
wherein the controller is configured to:
receive, via the input/output port, values for one or more variables sensed by sensors monitoring an engine and/or cooling system connected to the engine;
determine a set point trajectory for one or more engine component and/or cooling system temperatures based, at least in part, on the received values for one or more variables; and
send, via the input/output port, control signals to adjust positions of engine actuators and/or cooling system actuators to drive values of the engine component temperatures to the determined set point trajectories based, at least in part, on the received values for one or more variables.

16. The system of claim 15, wherein the engine component and/or cooling system temperatures include one or more of:
engine housing material temperature;
engine intake manifold air temperature;
engine exhaust manifold air temperature;
engine oil temperature; and
transmission oil temperature.

17. The system of claim 15, wherein the controller is configured to determine the set point trajectory for one or more engine component temperatures and/or cooling system component temperatures based, at least in part, on a powertrain cost function.

18. A method of thermal management of a powertrain system, the method comprising:
receiving a value for one or more variables sensed in an operating engine;
determining a set point trajectory for a temperature condition of the engine based, at least in part, on the received value for one or more variables sensed in the operating engine; and
outputting one or more control signals controlling positions of actuators of the engine and/or positions of actuators of a cooling system connected to the engine during operation of the engine; and
wherein the control signals are configured to adjust one or more positions of the actuators of the engine and/or of the cooling system to drive a value of the temperature condition to the determined set point trajectory for the temperature condition.

19. The method of claim 18, wherein determining a set point trajectory for a temperature condition of the engine comprises determining a temperature set point trajectory for one or more of engine components of the operating engine.

20. The method of claim 18, wherein the set point trajectory for a temperature condition of the engine is based, at least in part, on a cost function for the operation of the engine.
